(19) United States
(12) Patent Application Publication
(10) Pub. No.: US 2017/0323349 A1
(43) Pub. Date: Nov. 9, 2017

(54) OFFLINE-TO-ONLINE MASS PERSONAL DIRECT MAIL AUTOMATION SYSTEM AND METHODS

(71) Applicant: Prospect Smarter, Inc., Tampa, FL (US)

(72) Inventors: Paul Blaylock, Tampa, FL (US); Angela Medlar, Tampa, FL (US); Ryan LaNeve, Tampa, FL (US)

(21) Appl. No.: 15/587,343

(22) Filed: May 4, 2017

Related U.S. Application Data
(60) Provisional application No. 62/332,446, filed on May 5, 2016.

(51) Int. Cl. G06Q 30/02

(52) U.S. Cl. CPC G06Q 30/0271

(57) ABSTRACT

The system and methods of the present invention enable a paradigm shift in mass mailing campaigns wherein printing personalized images in a mailer takes the conventional focus of direct mailing from the marketer and fundamentally changes the focus to the recipient. The recipient is at the center of the correspondence, not the marketer's desire to sell a service or product. The recipient notices this shift and is more likely to engage with the marketer. The mailer greatly facilitates allowing the recipient to go from the offline medium of the mailer to an online Web page where additional personalized content may be displayed. The marketer may be notified, for example via SMS or phone call, as soon as the Web page is visited by the recipient.

### CROSS-REFERENCE TO RELATED APPLICATIONS

The present application claims priority to Provisional Application No. 62/332,446, filed May 5, 2016, entitled “OFFLINE TO ONLINE MASS PERSONAL DIRECT MAIL SYSTEM”, under 35 U.S.C. §119, hereby incorporated in its entirety and for all purposes.

### BACKGROUND OF THE INVENTION

### 1. Field of the Invention

The present invention relates to software for automating direct mail processes. More specifically, it relates to software for creating customized mailers at mass scale with personal images and text such that engagement with a recipient is greatly enhanced.

### 2. Description of the Related Art

Presently, direct mail campaigns are not as effective as the marketers (senders of the direct mail) would like them to be. The vast majority of mailer recipients, whether businesses or individual consumers, do not respond to direct marketing mail, leading to a very low conversion rate. They fail to engage with the potential customer. One attempt to increase the effectiveness of direct mail campaigns has been to personalize the mailer (the physical item received in the mail) so that some aspect of the content being received is personalized or customized to the recipient. While this has made direct mail campaigns more productive, such efforts have still fallen short. In addition, marketers are not able to measure or see how the recipients respond to the mail and are not able to follow up in a timely or engaging way with the recipient. Did the recipient see the mail? Did it get her attention? If so, was there some degree of interest? How can that interest be converted to actual engagement?

Another obstacle with traditional direct mail is the effort taken by marketers to execute a direct mail campaign. This often involves purchasing a mailing list, sourcing an artist to design the creative components of the campaign, working through creative revisions with a marketing team, finding a printer and negotiating pricing, and sending the files to the printer. The printer has a data team that runs the mailing list through postal presorting software, followed by a programming team that sets up the variable data from the list with the art, sends a proof to the client, works through revisions, and then finally produces a print ready file that ultimately makes it to the printer.

Related to mass mailing campaigns are Web to print operations which rely on a static design which may contain an image that is specific to a particular demographic. It may also include a high-level personalization, typically a database-driven personalization, such as “Hi Bob . . . .” However, these campaigns do not have the level of personalization, such as the ability to include personal or customized images. They also lack true one-to-one personalization which results in lower engagement rates (ROI) for mass mailing campaigns.

What is needed is a new paradigm of mass direct mail systems having various novel features that address the issues above and that is efficient for the party executing the direct mail campaign.

### BRIEF DESCRIPTION OF THE DRAWINGS

References are made to the accompanying drawings, which form a part of the description and in which are shown, by way of illustration, specific embodiments of the present invention:

FIG. 1 is a flow diagram of a process of creating a process for a marketer and storing it in a system database in accordance with one embodiment of the present invention;

FIG. 2 is a flow diagram of a process executed in an imposer module in accordance with one embodiment;

FIG. 3 is a flow diagram of a process of using a mobile application for creating and sending a personalized mailer in accordance with one embodiment; and

FIG. 4 is a block diagram showing components of a computing device in accordance with one embodiment.

### SUMMARY OF THE INVENTION

In one aspect of the present invention, a system has the ability to efficiently design, prepare, and mail a high volume of direct mailings each of which may be personal to the recipient, thereby facilitating offline to online engagement with potential customers. In one embodiment, components and modules of the present invention may be characterized as a direct mail starter kit enabling a marketer to gain efficiencies, scale, and eliminate pain points. In another embodiment, the present invention may be characterized as a mobile tool or platform to enable a marketer to prepare and send individual personalized direct mailers.

The system and methods of the present invention enable a paradigm shift in mass mailing campaigns wherein printing personalized images in a mailer takes the conventional focus of direct mailing from the marketer and fundamentally changes the focus to the recipient. The recipient is at the center of the correspondence, not the marketer's desire to sell a service or product. The recipient notices this shift and is more likely to engage with the marketer. The mailer greatly facilitates allowing the recipient to go from the offline medium of the mailer to an online Web page where additional personalized content may be displayed. The marketer may be notified, for example via SMS or phone call, as soon as the page is visited by the recipient.

In one aspect of the present invention, a method of executing a mass mailing campaign is described. A system receives recipient contact data from a marketer. It also receives mailer template data which may include design instructions, messages, photos, and the like. A mass mailing process is created for the marketer and stored in a database. An imposer module executes on the process and performs postal pre-sorting and other postal operations to prepare the mailers. An image that is personal or specific to a recipient may be inserted into the mailer. A print file is composed and transmitted to a print shop where the mailer is printed and mailed.

### DETAILED DESCRIPTION OF THE INVENTION

Example embodiments of a mass mailing system for automatically creating and sending personalized mailers at scale are described. These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

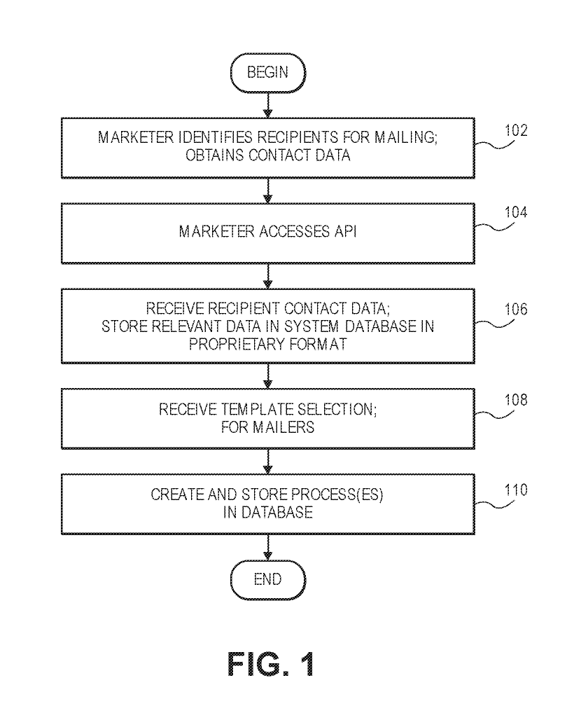

FIG. 1 is a flow diagram of a process of creating and storing processes for a marketer in a system database in accordance with one embodiment. The process starts external of the inventive mass mailing system. At step 102 a marketer (or any party which wants to send mass personalized mail to a known group of recipients) collects or consolidates contact data for each recipient, such as business name or individual name, address, email address, phone number, and the like. The recipients are typically potential customers, actual customers, leads, patrons, associates, and other types of contacts. This data may be stored in one or more customer relationship management systems. At step 104 the marketer accesses an API for the inventive system operated by the service provider. This can be done via a user interface at the service provider's Web site or via an automated trigger such as a workflow rule in a CRM, such as HubSpot, that triggers a mailer when a contact qualifies to receive a mailer based on a previously defined business rule, as described below. In one embodiment, the API is able to integrate with various widely used CRM systems, such as Salesforce, HubSpot, and SharpSpring. It can also integrate with databases that store recipient contact data. The marketer specifies which CRM it is using for the data.

It is during this upload process when, the marketer also makes selections on the design of the mailer using a template that can be accessed through a UI at the Web site of the service provider implementing the mass mail campaign for the marketer. Design choices include attachments, messages, notes, colors, fonts, etc. It can also specify when or how often the mailers should be sent and other work flow instructions including, as noted, messages, images and online content for each recipient. For example, work flow instructions can include triggers, some of which are integrated with the CRMs, such as “Send a mailer if the recipient has not yet converted to customer or engagement”, “Send a mailer if the sales rep and recipient have not had meeting yet”, or “Send a ‘Thank You’ mailer if recipient has converted or engaged” and the like. These can also be specified in the marketer's CRM. As described in greater detail below, the service provider can also insert a personal image, also referred to as a variable image, into the template for one or more recipients on behalf of the marketer.

At step 106 the perspective of the process (flow diagram) changes to the service provider. The service provider determines which CRM is being used or whether the data is being sent as database files or flat files (the marketer can specify the CRM or database vendor via the UI). The service provider receives the contact data files, the design template, and begins the CRM integration process. The contact data is converted to a proprietary format and stored in a system database that is in communication with the API. Concurrently, at step 108 the workflow instructions and the design template from the marketer is also stored and linked or coupled to the contact data. Together the design template, workflow instructions and contact data form a batch process for that marketer (also referred to as a job) which is stored in the database. As noted, this process has instructions on when a module, referred to herein as an imposer module, described below, should run the process. A marketer may have more than one process if it wants to run separate mailings at different times for its recipients who may be comprised of different types of recipients (e.g., businesses, individuals, partners, investors, etc.). At step 110 the one or more processes for that marketer are created and stored in the system database. At this stage the service provider is able to run the imposer module to create the mailers and transmit the files to a printer (vendor) for printing and mailing.

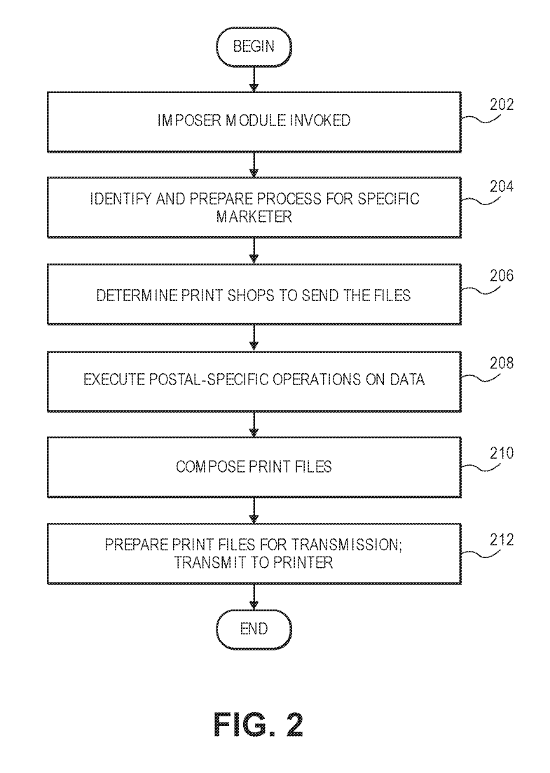

FIG. 2 is a flow diagram of a process for creating and preparing mass mailers in accordance with one embodiment. At step 202 the service provider invokes a module that executes jobs or processes from the database at scheduled times as dictated by workflow instructions. Unscheduled jobs can also be executed for a marketer when needed on demand. As noted, the module is referred to as an imposer module and can be executed automatically or manually via the UI and API.

At step 204 the imposer (or the service provider) identifies and prepares a process to be run for a specific marketer. As noted above, a process contains the marketer's contact data, design template, and instructions. A process can be characterized as a print order. At step 206 the imposer determines which printers (vendors) to send the print files (the actual print files are created in steps 208 and 210). This can be done based on recipient address. Mailings to recipients in one region may go to one print shop and mailings for another region can go to a different vendor that is closer to that region. For large mass mailings, there may be multiple print shop locations. At step 208 the imposer performs a series of postal-specific operations on the contact data. These include preparing the recipient list for mailing by running postal processes, specifically, NCOA, CASS, DPV, Presort, some of which can reduce the cost of postage and mailing, and generating postal paperwork. Determining which print shops to send the print files to at step 206 needs to be done before running the imposer so that the imposer can properly execute the Presort and generate the correct postal paperwork.

At step 210 the imposer module composes one or more print files for the process. A print file contains the mailers in final form which can be printed and mailed with minimal additional processing, typically performed by print shops. There may be multiple print files for a single process. At step 212 the print files are prepared for transmission to the print shops and transmitted via File Transfer Protocol (FTP) or any other suitable means. The printer shop receives a print-ready file, prints the mailers, prepares the mailers for mailing, and mails them.

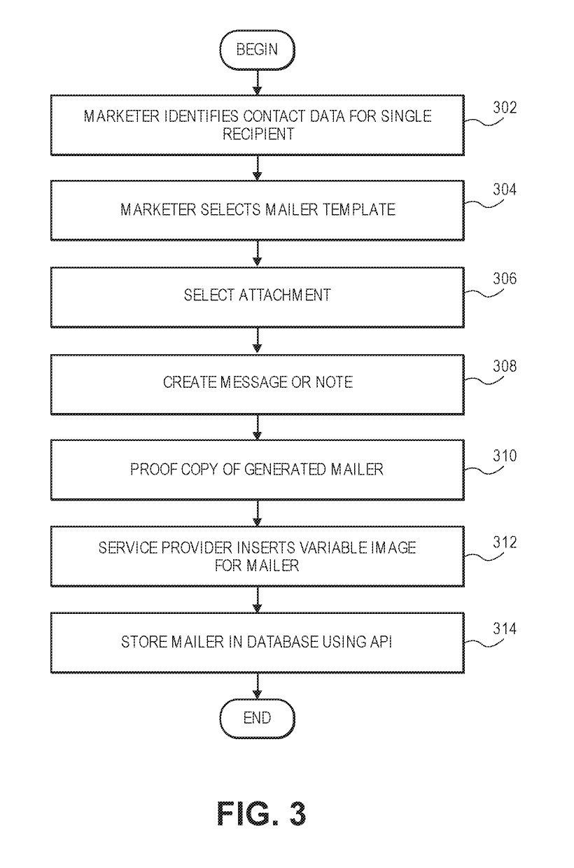

FIG. 3 is a flow diagram of a process for preparing a mailing (or a small number of mailings) using a mobile application in accordance with one embodiment. This process may occur when a marketer wants to prepare and send one mailer for an existing or new contact at any time from any location. A marketer can use a mobile application to access a mobile UI via the API. She can also perform the same operations from the Web UI. At step 302 a marketer identifies or enters contact information for the recipient. This can be retrieved from a CRM, database, retrieved from the marketer's mobile device, or entered by the marketer if it is new.

At step 304 the user selects a mailer design template or uploads a new one. Here the marketer can selects a design for the mailer. The marketer can also take a photo with her mobile device and use the photo as part of the design. At step 306 the marketer selects an attachment if there is one. At step 308 the marketer can insert a personalized message or note to further customize the mailer. For example, if the marketer just met the recipient at an event, the note can be something specific about their first meeting. At step 310 the marketer has an opportunity to proof a copy of the mailer generated by the mobile app. At this stage changes can be made to the mailer, such as using a different design, attachment, message, or note. If the proof is approved, control goes to step 312 where the service provider may, at the instruction of the marketer, find a variable image relating to the recipient or the marketer (depending on the context of the mailer), and insert it into the template for the mailer. This variable image can be pulled from a wide variety of sources. The image itself can also vary greatly. Some examples are images from social media profile images, website screenshots, company logos, or pictures that are specific to the recipient (such as a picture of the marketer and recipient at the event). At step 312 the mailer is transmitted to the service provider and stored in the system database via the service provider API. Once the file for the mailer is in the database, the imposer module may pull it immediately (it does not have to be a scheduled process) and prepares it for printing and mailing. In this manner, a mailer can be created “on the spot” by the marketer for a new potential customer and printed and mailed, all in one day.

Once a recipient receives a mailer, the likelihood that she will engage with the marketer because of the high degree of one-to-one personalization of the mailer with respect to the written text (notes, messages, etc.) and images, which can be a photo of the recipient with the marketer or a variable image found by the service provider, that has some meaning to the recipient. There may also be a QR code, unique access code or a URL for the marketer that makes it easy for the recipient to start engaging with the marketer. If the recipient does go to the marketer's web page and enters a code unique to the recipient, the marketer can be notified right away (e.g., via SMS, outbound dial, CRM push or via email) that this recipient has responded, giving the marketer the chance to move quickly to start a dialogue with the potential or existing customer, partner, associate, etc.

As illustrated in the flow diagrams, one of the main objectives of the present invention is the ability to efficiently send a high volume of mailings wherein each of the mailings is highly personal to the recipient, facilitates offline-to-online engagement, and enables the marketer to respond to a potential engagement quickly. In one embodiment, software components, databases, the mobile app, the imposer, and other modules of the present invention may be characterized collectively as a direct mail starter kit enabling a marketer to scale, thereby gaining efficiencies, and eliminating pain points often experienced with conventional mass mailing campaigns. In another embodiment, the present invention may be characterized as a mobile tool to enable a marketer to prepare and send single, timely, and personalized direct mailers with minimal effort.

It is useful to describe two scenarios illustrating how different embodiments of the invention can be used. In one scenario, a marketer begins a direct mass mailing campaign to thousands of recipients over a wide geographical area. The marketer has recipient contact data in a CRM or CRM-like data store. As noted, the CRM can be a product from one or more of different vendors. A marketer may use two or more different CRMs (e.g., Sugar and HubSpot) and integrate them with the API simultaneously. The API of the mass mailing system of the present invention is able to integrate with various CRM vendors. The marketer can use the present invention to prepare personal direct mail letters or mailers to each of the thousands of recipients with minimal effort and resources by the marketer. Each direct mail letter may have an image, provided by the marketer or found by the service provider, that is, specific to the recipient (e.g., the recipient's LinkedIn page, a picture of the recipient's house, a map showing a route to marketer's business, or from an abandoned online shopping cart of the recipient). The image is intended to grab the attention of the recipient when she receives the mailer. The mailer may also have a URL or a code that the recipient uses to go to a marketer's landing page online, thereby making an offline to online shift in the engagement (i.e., from physical mailer in hand to viewing a Web site). For example, the landing page may have a video by the marketer that plays for the recipient. The video may be personal or unique to that recipient, further increasing the likelihood of engaging the recipient, or the video may be intended for a general or targeted audience. The marketer can also attach a Web page or document. Once the recipient goes to the online landing page, the marketer may be notified, for example with a phone call or a text, informing him that a specific recipient has gone to the landing page (or for example watched a video) and provides the recipient's phone number, or the system may push to the marketer's CRM or Marketing Automation System or execute an autodial to the recipient on behalf of the marketer. The marketer can then contact the recipient right away and convert the initial interest into an engagement. Through utilizing the API to get contact data from a CRM plus dynamic, personal image generation, and efficient printing and mailing modules, the direct mass personal mailing can be done with minimal effort by the marketer.

In another scenario, a marketer wants to send a single, timely personal mailer to a recipient, maybe a new potential lead or customer. Here, the marketer may have a recent photo taken with the recipient at an event or trade show. The marketer wants to send the mailing as soon as possible. She can use the mobile app on her mobile device or the Web app from a browser to prepare and send this “one off” mailing. The app has a UI that the marketer can use to load the photo and input contact information which she may have just obtained (or get that information from a CRM, or from an address book on the mobile device, if the recipient is not new). She can write a note for the mailer and upload an attachment, such as a Web page, document, or video. At the last step, the mailer is proofed by the marketer on the mobile device (e.g., to ensure that the entire image uploaded or that the address is correct) and releases it to the imposer as a process.

The imposer module ensures that the mailer is printed and mailed to the recipient on the date specified by the marketer (e.g., the same day or next day, week, etc.). However, for the one-off cases, the marketer may want to the send the mailer immediately so instructions are provided via the app to have the imposer run the process right away or as soon as possible. There are several other scenarios, use cases, and variations in which the tools of the present invention can be used to create personal direct mailers, as will be apparent from the description below.

To recap the description above and add more detail, the processes of the present invention start with a marketer wanting to send out direct mass personal mailings. Contact information for each recipient is stored in a database, such as a CRM database or other type of file under control of or available to the marketer. For this, there is the system API that can be used by the marketer (or a 3^{rd} party developer) either through a Web UI or a mobile UI, or as part of an automated process. These integrations between the API and different CRMs enable receiving contact information and storing relevant data in the system database together with workflow instructions.

In the embodiments described above, the marketer is the user of the novel direct mass personal mail system. In one embodiment, the system, embodying novel features of the invention, is owned and operated by a direct marketing service provider and is offered as a service to marketers (who are essentially customers of the service provider). The individuals, businesses, and other entities who receive the personal mailers, the recipients, are, in most cases, actual customers, potential customers, contacts, leads, patrons, job candidates, investors, associates, and the like, of the marketer.

After the addresses of the recipients who the marketer wants to send direct personal mailers to are in the service provider database in a specific format (or in a database accessible to the service provider), the process of preparing each of the individual personal mailers can begin. The marketer selects a template for the mailer which shows how the mailer will look, its design, format, where logos will be placed, what colors to use, fonts, etc. One can be chosen from a mailer template library managed by the service provider or one can be provided by the marketer, as long as it conforms to the service provider's parameters. The marketer also provides the service provider with personal notes or messages that will go in mailer. The marketer can also provide personal text (e.g., a special note or message) for as many recipients as desired (this requires additional effort from the marketer but increases the likelihood of interest from the recipient). As noted, this is also what is done by the marketer when using the mobile app (supplied by the service provider) in the “one off” scenario described above, where the marketer writes a personalized note for the recipient.

One of the novel features of the invention and what makes the mailer personal to each recipient is the one or more personal images in the mailer. Each image may be unique to the recipient, but does not have to be. The image may also be templated art. For recipients who are individuals or retail consumers, the image can be a picture that shows their home or family members, and for businesses and other entities, it can be a more professional picture (e.g., a picture of the marketer and an officer of the company at a convention or corporate retreat, or an image from a LinkedIn page, and so on).

In one embodiment, software under control of the service provider finds a suitable image for a specific personal mailer based on the context, namely, either personal or professional, as instructed by the marketer. This image can be pulled from a wide variety of sources, many of which the marketer may not have the technical savvy or means to obtain. In this manner, the marketer is able to get personalized image and thereby get the attention of the recipient when the recipient receives the letter, card, brochure, etc., because the image is personal or, at least directly relevant to the recipient. For example, in the consumer context, the marketer may be a car dealership and the image may be a map showing the route from the recipient's home to the dealership or be a picture of the recipient's car in her driveway (with a note saying they now have this year's model of her car on the lot). In the business context, the picture may be of the marketer and an executive of the business at a recent trade show, which is likely to get the attention of decision makers at the company, or an image that the service provider is able to find from a source that is less accessible to the marketer.

One feature of the paradigm shifting aspect of the present invention is showing such personal images in a mailer. This takes the conventional focus of direct mailing from the marketer (the entity sending the mailer) and changes it to the recipient. The recipient is at the center of the correspondence; the marketer's desire to sell a service or product becomes secondary.

As described above, another component of the present invention is the imposer module. In one embodiment, it is run as a Web application. In FIG. 1, the necessary CRM data has been pushed from the marketer's CRM to the service provider's database using the API. The data and instructions, scheduling information, and the like are contained in a process (i.e., a batch job) that is run by the imposer. This can be done on a regular basis, such as daily or whenever a threshold number of scheduled processes have been collected, for example, when a minimum order quantity has been met for a particular print shop (vendor). Several actions take place when this is done. First, the scheduled processes for the pre-defined period are identified or prepared for execution. A process is, at a high level, a direct personal mass mailing job for a specific marketer. A process can also be a single mailer or a small number of mailings that a marketer wants as a trial. As such, the imposer is a flexible and scalable component of the system that allows preparation of tens of thousands of mailers or one mailer in either case can be scheduled regularly or on an as needed basis. The imposer can be utilized as a Web application, the mobile app, or a 3^{rd} party app, all via the API.

The imposer module may be described as a scheduled procedure that performs several operations: aggregating all print orders, dividing the individual orders up by any number of printers (vendors) (based on location of marketer or recipient), preparing the mailers for mailing by running postal processes (e.g., NCOA, CASS, DPV, Presort—which can reduce the cost of postage and mailing), generating postal paperwork, preparing the mailers for mailing, such as adding other indicia, address blocks, barcodes, and finally imposing into one file for each fulfillment house. This file, the final print and postal paperwork file, is then then transferred via FTP. The imposer can be configured to run on any given schedule and for any given fulfillment center.

A batch of scheduled processes is outputted from the database. The imposer performs operations on the data in each process. As noted, the imposer takes the data and prepares the mailers for each customer, including several post office or postal-specific operations. The imposer also composes and prepares the print file for each process or batch job. This file is then transmitted to a printing shop. In some cases, it may be sent to a printer that is local to the customer. Proximity of the printer can be important when there is a high volume of mailers. In some cases, for larger customers, there may be a network of printers in different locations and which printer is used depends on the location of the recipients and not of the marketer. As such, there is logic behind selecting a printer and where to send the FTP files for a marketer. The printer must be suitable for the type of format, design specifications, and other factors of the actual mailer (i.e., the physical card or letter that the recipient will hold). At the printer, the mailer is printed and the print shop is responsible for the actual mailing.

A mobile app can be used by marketers to create the one-to-one, micro-personal mailers, the “one-off” mailers as described above. And since it is a mobile app, it can be done by the marketer while traveling without the need of using the Web application. As is known in the field of marketing and sales, timeliness can be very important. The mobile app allows a marketer to input new contact information (e.g., from a business card she just received), find a personal image or supply one (e.g., a photo taken that day of the marketer and the recipient), proof the final design, and have the imposer prepare the mailer that night to be mailed the next day for that single recipient. The marketer can select a contact from one of various sources, such as the service provider database, the marketer's mobile device, or input new contact data. The marketer may then select a mailer design or upload a new design. The marketer can then select an attachment and message. After these steps, the marketer and/or the service provider may proof the mailer. The mailer is then stored in the service provider database via the API. Once the mailer is created, it is stored in the database from where the imposer gets the data for the job needed to get the mailer printed and sent to the recipient.

In one embodiment, the process taken by the service provider of finding a personal image for each recipient may be different or the same process may be used, depending in part on whether the mailer is for a business or for an individual consumer.

In another embodiment, the customer may only want a code for the mailer without the actual mass mailer preparation done by the service provider. The customer may import their mailing list to the database and export a list of codes to append to their mail piece.

With the API of the present invention, the system described above can integrate with third-party software, specifically CRMs, that can send and receive data to automate the sending of direct mail. As described in detail above, the primary use for this is the CRM or marketing automation system. Business rules can be setup in the third-party software to trigger mailers from the system using a set template. Some examples are provided earlier (e.g., “Send a mailer if the recipient has not yet converted to customer or engagement”, “Send a mailer if the sales rep and recipient have not had meeting yet”, etc.). When there is a response, the system triggers a field change in the third-party software to trigger the next steps.

For example, a sales representative may work out of a CRM system, call the same lead numerous times and deem that lead unresponsive. The CRM system would programatically send that lead's data to the system of the present invention to automatically generate a personal mailer with a note and images, without any interaction from the sales rep. The mailer may use a set template previously defined by a marketing user working with the sales rep.

When the lead gets the personalized card in the mail she can go online and enter the code in the mailer to retrieve their online content. At that time, the system programatically sends a message to the CRM system. For example, it can change the lead's status back to NEW and trigger an outbound phone call from the sales rep. start here

As described above, the invention has several novel features. On the front end, they include dynamically finding images for each recipient, timely notifications to the marketer and enabling immediate response, IVR, and enabling a marketer landing page. The invention leverages the simplicity of direct mail campaigning and may use a user-generated image or system-generated images to take the recipient from offline to online. Another important feature of the invention is the collective result of several individual novel features, namely, creating a feedback loop for the marketer. Specifically, the marketer is informed right away of when the recipient has gone online (by entering a code or URL for example) and has watched (or is still watching) a video on the landing page and is texted the recipient's phone number or email address so the marketer can contact the recipient in a timely manner. And by doing so, the system is completing a feedback loop for the marketer.

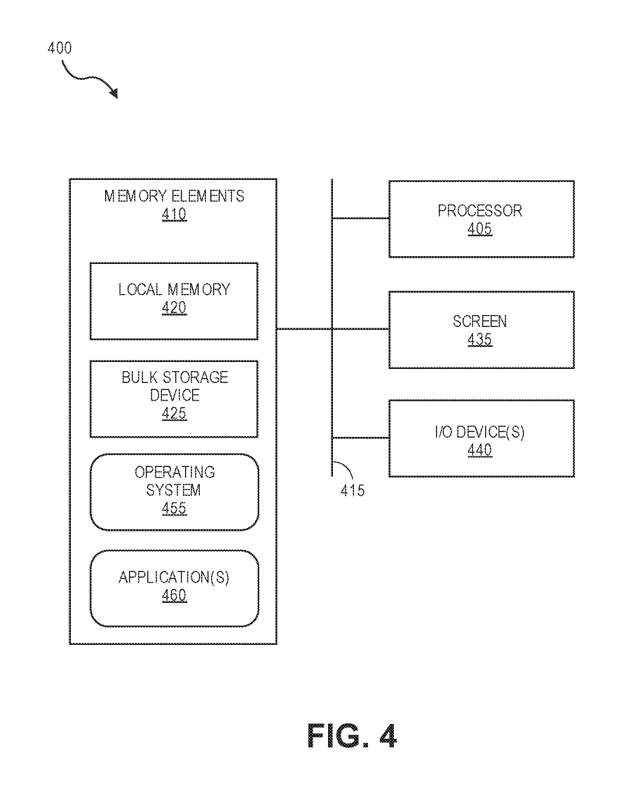

FIG. 4 is a block diagram of a data processing system 400 in accordance with one embodiment. System 400 may be used to implement any of a variety of systems and/or computing devices that include a processor and memory and that are capable of performing the operations described within this disclosure. It can be used to execute computer instructions to implement the logic flowcharts in FIGS. 1 to 3.

As pictured, system 400 includes at least one processor 405 coupled to memory elements 410 through a system bus 415 or other suitable circuitry such as an input/output (I/O) subsystem. System 400 stores program code within memory elements 410. Processor 405 executes the program code accessed from memory elements 410 via system bus 415. Memory elements 410 include one or more physical memory devices such as, for example, a local memory 420 and one or more bulk storage devices 425. Local memory 420 refers to random access memory (RAM) or other non-persistent memory device(s) generally used during actual execution of the program code. Bulk storage device 425 may be implemented as a hard disk drive (HDD), solid state drive (SSD), or other persistent data storage device. System 400 may also include one or more cache memories (not shown) that provide temporary storage of at least some program code in order to reduce the number of times program code must be retrieved from bulk storage device 425 during execution.

System 400 may be coupled to one or more I/O devices such as a screen 435 and one or more additional I/O device(s) 440. The I/O devices described herein may be coupled to system 400 either directly or through intervening I/O controllers. In one aspect, screen 435 may be implemented as a display device that is not touch sensitive. In another aspect, screen 435 may be implemented as a display device that is touch sensitive.

Examples of I/O device(s) 440 may include, but are not limited to, a universal remote control device, a keyboard, a mobile device, a pointing device, a controller, a camera, a speaker, and a microphone. In some cases, one or more of the I/O device(s) may be combined as in the case where a touch sensitive display device (e.g., a touchscreen) is used as screen 435. In that case, screen 435 may also implement a keyboard and a pointing device. Other examples of I/O devices 440 may include sensors. Exemplary sensors may include, but are not limited to, an accelerometer, a light sensor, touch screen sensors, one or more biometric sensors, a gyroscope, a compass, or the like.

I/O devices 540 may also include one or more network adapter(s). A network adapter is a communication circuit configured to establish wired and/or wireless communication links with other devices. The communication links may be established over a network or as peer-to-peer communication links. Accordingly, network adapters enable system 400 to become coupled to other systems, computer systems, remote printers, and/or remote storage devices, such as remote servers storing content. Examples of network adapter(s) may include, but are not limited to, modems, cable modems, Ethernet cards, wireless transceivers, whether short and/or long range wireless transceivers (e.g., cellular transceivers, 802.11x (Wi-Fi™) compatible transceivers, Bluetooth® compatible transceivers, and the like).

As pictured in FIG. 4, memory elements 410 may store an operating system 455 and one or more application(s) 460, such as applications for translating symbols and zero-amplitude time durations and symbol mapping tables. It may also store software for segmenting or breaking a message (to be transmitted) into pieces or segments that can be represented by symbols. In one aspect, operating system 455 and application(s) 460, being implemented in the form of executable program code, are executed by system 400 and, more particularly, by processor 405. As such, operating system 455 and application(s) 460 may be considered an integrated part of system 400. Operating system 455, application(s) 460, and any data items used, generated, and/or operated upon by system 400 are functional data structures that impart functionality when employed as part of system 400.

In one aspect, system 400 may be used to implement a computer, such as a personal computer, a server, or the like. Other examples of mobile computing devices may include, but are not limited to, a tablet computer, a mobile media device, a game console, a mobile internet device (MID), a laptop computer, a mobile appliance device, or the like.

System 400 may include fewer components than shown or additional components not illustrated in FIG. 4 depending upon the particular type of device that is implemented. In addition, the particular operating system and/or application(s) included may also vary according to device type as may the types of network adapter(s) included. Further, one or more of the illustrative components may be incorporated into, or otherwise form a portion of, another component. For example, a processor may include at least some memory.

Various embodiments described herein involve distinct features. It should be appreciated that any feature or functionality from one figure or embodiment may be incorporated into any other figure or embodiment.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

What is claimed is:

1. A method of executing a mass mailing campaign comprising:
receiving recipient contact data from a marketer;
receiving mailer template data from the marketer;
creating a mass mailing process for the marketer;
storing the process in a database;
invoking an imposer module;
inserting into the mailer an image personal to a recipient; and
transmitting a print file to a printer, wherein the mailer is personal to the recipient thereby placing focus of the mailer on the recipient.

2. A method as recited in claim 1 wherein invoking an imposer module further comprises:
identifying and preparing the process;
executing the process based on a scheduled time; and
executing postal-specific operations to prepare the mailers.

3. A method as recited in claim 1 further comprising including one or more of an attachment and a message in the mailer template.

4. A method as recited in claim 1 further comprising:
storing contact data in the database; and
storing mailer template data in the database.

5. A method as recited in claim 1 further comprising:
composing a print file for the marketer.

6. A method of creating and mailing a personalized mailer, the method comprising:
receiving contact data for one recipient;
receiving a template selection for the mailer;
generating a personalized mailer for the recipient;
inserting a variable image relevant to the recipient into the mailer;
storing a final mailer in a database as a process;
invoking an imposer module thereby executing the process; and
sending the generated mailer to a print shop, wherein the mailer is printed and mailed to the recipient.

7. A method as recited in claim 6 further comprising:
receiving an attachment from the marketer to be included in the mailer.

8. A method as recited in claim 6 further comprising:
receiving additional content from the marketer to be included in the mailer.
